(19) United States
(12) Patent Application Publication
(10) Pub. No.: US 2006/0282218 A1
(43) Pub. Date: Dec. 14, 2006

(54) Vehicle travel safety apparatus

(75) Inventors: Yoshihiro Urai, Utsunomiya-shi (JP); Yoichi Sugimoto, Utsunomiya-shi (JP); Hiroyuki Koike, Utsunomiya-shi (JP)

Correspondence Address: BRIAN M BERLINER, ESQ;O'MELVENY & MYERS, LLP, 400 SOUTH HOPE STREET, LOS ANGELES, CA, 90071-2899, US

(73) Assignee: HONDA MOTOR CO., LTD.

(21) Appl. No.: 11/448,352

(22) Filed: Jun. 6, 2006

(30) Foreign Application Priority Data
Jun. 14, 2005 (JP) P2005-173338

(51) Int. Cl. G08G 1/16

(52) U.S. Cl. 701/301; 342/455; 340/903; 340/436

(57) ABSTRACT

A vehicle travel safety apparatus which includes: an object detecting device that detects objects around the vehicle; a first travel path estimating device that estimates the travel path of a moving object among the objects; a velocity calculating device that calculates the velocity of the moving object; a travel state detecting device that detects the travel state of the vehicle; a second travel path estimating device that estimates the travel path of the vehicle; a collision judgment device that determines whether or not there is a possibility of a collision occurring between the moving object and the vehicle; and a travel control device that controls the travel of the vehicle, wherein the collision judgment device estimates an ease of evasive action in the event of the moving object avoiding a collision with the vehicle, and the travel control device controls the travel of the vehicle so that the ease of evasive action increases.

### BACKGROUND OF THE INVENTION

1. Field of the Invention

The present invention relates to a travel safety apparatus for a vehicle.

Priority is claimed on Japanese Patent Application No. 2005-173338, filed Jun. 14, 2005, the content of which is incorporated herein by reference.

2. Description of Related Art

There is conventionally known an anti-collision system for vehicles that uses an object-detecting means such as a radar for detecting the presence of an obstruction in the vicinity of a subject vehicle, estimates the path of travel of the obstruction and the path of travel of the subject vehicle, calculates the possibility of collision between the obstruction and the subject vehicle based on the estimated paths of travel, and, in accordance with the calculated collision possibility, automatically controls the running state of the subject vehicle (such as by controlling vehicle velocity) so as to prevent a collision with the obstruction (refer, for example, to Japanese Unexamined Patent Application, First Publication No. H07-104062).

Since such an anti-collision system in the prior art serves to prevent collisions solely by controlling the running state of the subject vehicle, in the event of the system judging a collision to be unavoidable based on travel control of the subject vehicle, collision reduction control is performed simply to reduce the impact of a collision, regardless of the possibility of a change in the travel state of the obstruction. As a result, in the event of the obstruction executing appropriate evasive action, excessive or unnecessary travel control ends up being applied to the subject vehicle.

### SUMMARY OF THE INVENTION

The present invention was made in view of the above circumstances, and has as its object to provide a vehicle travel safety apparatus that executes appropriate evasive action when there is the possibility of a collision between a subject vehicle and a moving object in the vicinity of the vehicle.

A first aspect of the present invention recites a travel safety apparatus for a vehicle, the apparatus including: an object detecting device that detects objects around the vehicle; a first travel path estimating device that estimates a travel path of a moving object among the objects; a velocity calculating device that calculates the velocity of the moving object based on a detection result of the object detecting device; a travel state detecting device that detects a travel state of the vehicle; a second travel path estimating device that estimates the travel path of the vehicle based on a detection result of the travel state detecting device; a collision judgment device that determines whether or not there is a possibility of a collision occurring between the moving object and the vehicle based on an estimated moving object travel path that is estimated by the first travel path estimating device, an estimated vehicle travel path that is estimated by the second travel path estimating device, the velocity of the moving object calculated by the velocity calculating device, and the travel state; and a travel control device that controls the travel of the vehicle when a determination result of the collision judgment device indicates a possibility of a collision occurring, wherein the collision judgment device estimates an ease of evasive action in the event of the moving object avoiding a collision with the vehicle, and the travel control device controls the travel of the vehicle so that the ease of evasive action increases.

According to the aforementioned vehicle travel safety apparatus, when the travel control device controls the travel of a subject vehicle so as to avoid a collision between a moving object and the subject vehicle or reduce the force of impact when a collision occurs, it performs such control so that the ease of evasive action in the event of the moving object avoiding a collision with the subject vehicle rises. Thereby, even in the event of a collision being judged as unavoidable solely by travel control of the subject vehicle, the possibility of a collision occurring can be reduced due to evasive action on the part of the moving object. In addition, in the event of a collision being judged as avoidable solely by travel control of the subject vehicle, by taking into account the predicted evasive action of the moving object, only a minimal level of required travel control is performed on the subject vehicle. Thus, it is possible to prevent excessive or unnecessary travel control from being executed on the subject vehicle.

The collision judgment device may estimate the point of collision between the moving object and the vehicle based on the estimated travel path of the moving object, the estimated travel path of the vehicle, the velocity of the moving object, and the travel state, and the travel control device may control the travel of the vehicle so that the vehicle moves away from the collision point and the moving object.

Executing travel control of the subject vehicle so that the subject vehicle moves away from the point of collision and the moving object can improve the ease of the moving object to take evasive action, raise the possibility of a collision being avoided, and prevent the execution of excessive or unnecessary travel control on the subject vehicle.

The travel safety apparatus for a vehicle of the present invention may further include a velocity control device that controls a velocity of the vehicle, wherein the collision judgment device may estimate an amount of overlap of the vehicle and the estimated moving object travel path in the width direction of the estimated moving object travel path at the point in time when the moving object is estimated to arrive at the collision point, based on the estimated moving object travel path, the estimated vehicle travel path, the velocity of the moving object calculated by the velocity calculation device, and the travel state, and the velocity control device may control the velocity of the vehicle so that the amount of overlap decreases.

In this case, controlling the velocity (i.e., acceleration or deceleration) of the subject vehicle so that the amount of overlap between the estimated travel path of the moving object and the subject vehicle in the width direction of the estimated travel path of the moving object decreases can increase the ease of the moving object to take evasive action, and so increase the possibility of a collision being avoided.

The ease of evasive action may be one in the event of the moving object avoiding a collision with the vehicle by a steering operation. In this case, controlling the travel of the subject vehicle so as to reduce the amount of steering by the steering mechanism of the moving object required to avoid a collision can increase the ease of the moving object to take evasive action, and so increase the possibility of a collision being avoided.

The vehicle travel safety apparatus of the present invention may further include a velocity control device that controls the velocity of the vehicle, wherein the collision judgment device may estimate the collision point between the moving object and the vehicle based on the estimated travel path of the moving object, the estimated travel path of the vehicle, the velocity of the moving object calculated by the velocity calculation device and the travel state of the vehicle, and calculate an amount of movement when the moving object avoids the vehicle in a lateral direction before arriving at the collision point, and the velocity control device controls the velocity of the vehicle so that the amount of movement decreases.

In this case, controlling the velocity (i.e., acceleration or deceleration) of the subject vehicle so as to reduce the amount of movement when the moving object moves in the lateral direction by steering of a steering mechanism can increase the ease of the moving object to take evasive action, and so increase the possibility of a collision being avoided.

At least one of a moving distance in the lateral direction, a yaw rate, a lateral acceleration, and a steering angle of the moving object may be used as the amount of movement. In this case, by equating the amount of movement with at least any one of the moving distance in the lateral direction, the yaw rate, the lateral acceleration, and the steering angle of the moving object, the amount of movement of the moving object can be calculated with good accuracy.

The ease of evasive action may be one in the event of the moving object avoiding a collision with the vehicle by a braking operation. In this case, controlling the travel of the subject vehicle so as to reduce the braking force when the moving object applies braking by means of a braking device or the like can increase the ease of the moving object to take evasive action, and so as to increase the possibility of a collision being avoided.

The vehicle travel safety apparatus of the present invention may further include a steering control device that controls steering of the vehicle, wherein the collision judgment device may determine whether or not the moving object is to collide with a side portion of the vehicle based on the estimated moving object travel path, the estimated vehicle travel path, the velocity of the moving object calculated by the velocity calculation device, and the travel state, and the steering control device controls the steering of the vehicle so that the vehicle moves away from the moving object when it is determined that the moving object is to collide with the side portion of the vehicle.

In this case, controlling the steering of the subject vehicle so as to move away from the moving object can increase the ease of the moving object to take evasive action in the event of avoiding a collision by, for example, decelerating, and so increase the possibility of a collision being avoided.

### BRIEF DESCRIPTION OF THE DRAWINGS

FIG. 1 is a block diagram showing the constitution of the vehicle travel safety apparatus according to an embodiment of the present invention.

FIG. 2 is a drawing showing an example of the estimated travel path of an object vehicle in its present travel state and the estimated position of the subject vehicle in the case of maintaining its present travel state.

FIG. 3 is a drawing showing an example of the estimated travel path of an object vehicle in its present travel state and the estimated position of the subject vehicle in the case of acceleration.

FIG. 4 is a drawing showing an example of the estimated travel path of an object vehicle in its present travel state and the estimated position of the subject vehicle in the case of deceleration.

FIG. 5 is a flowchart showing the operation of the vehicle travel safety apparatus shown in FIG. 1.

FIG. 6 is a drawing showing an example of the estimated travel path of an object vehicle that turns to the right or to the left and the estimated position of the subject vehicle in the case of maintaining its present travel state.

FIG. 7 is a drawing showing an example of the estimated travel path of an object vehicle that turns to the right or to the left and the estimated position of the subject vehicle in the case of acceleration.

FIG. 8 is a drawing showing an example of the estimated travel path of an object vehicle that turns to the right or to the left and the estimated position of the subject vehicle in the case of deceleration.

FIG. 9 is a flowchart showing the operation of the vehicle travel safety apparatus according to the first modification of the embodiment.

FIG. 10 is a drawing showing an example of the estimated travel path of an object vehicle in its present travel state and the estimated position of the subject vehicle in the case of turning to move away from the object vehicle.

### DETAILED DESCRIPTION OF THE INVENTION

The vehicle travel safety apparatus according to one embodiment of the present invention shall now be described with reference to the accompanying drawings.

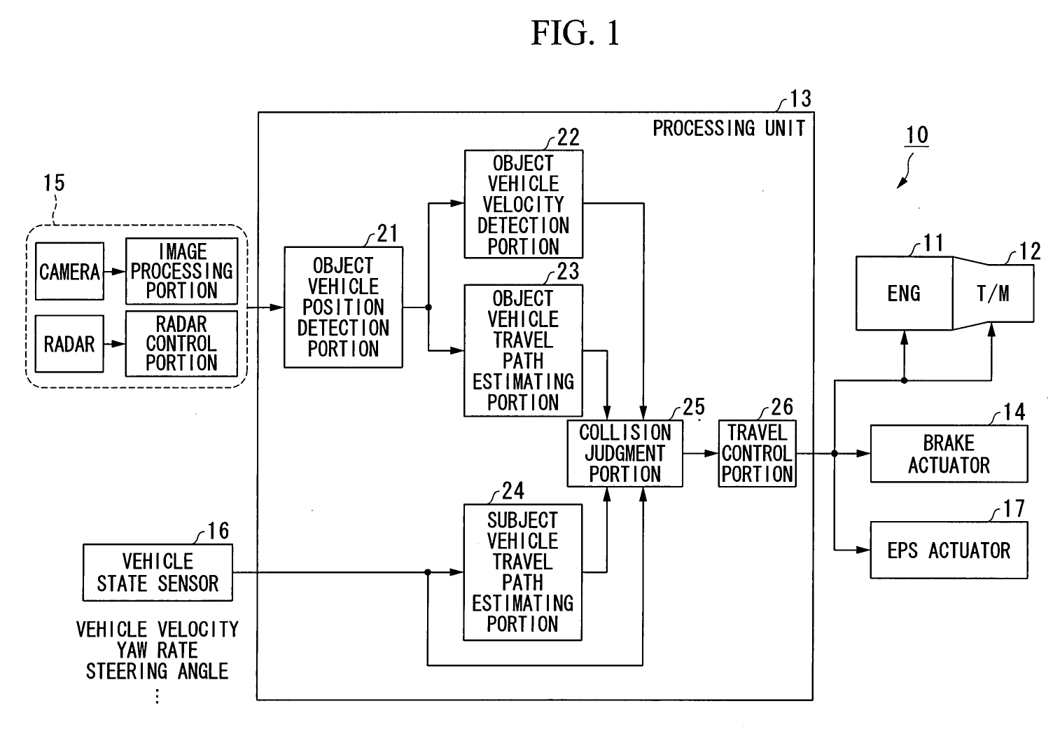

As shown in FIG. 1, a vehicle travel safety apparatus 10 according to the present embodiment is mounted in a vehicle that transmits drive power from an internal combustion engine 11 to the drive wheels of the vehicle by means of a transmission 12 such as an automatic transmission (AT) or a continuously variable transmission (CVT), and has a constitution provided with a processing unit 13, a brake actuator 14, an external sensor 15, a vehicle state sensor 16, and an EPS actuator 17.

In addition, the processing unit 13 has a constitution provided with an object vehicle position detection portion 21, an object vehicle velocity detection portion 22, an object vehicle travel path estimating portion 23, a subject vehicle travel path estimating portion 24, a collision judgment portion 25, and a travel control portion 26.

The external sensor 15 has a constitution provided with a camera consisting of a CCD camera or CMOS camera capable of performing imaging in the visible-light region and infrared region, an image processing portion, a laser-light or millimeter-wave radar, and a radar control portion.

The image processing portion performs specific image processing such as filtering and binarization of external images in the travel direction of the subject vehicle obtained by imaging of the camera, generates image data consisting of two-dimensionally arranged pixels, and outputs the image data to the processing unit 13.

In addition, the radar control portion emits a laser-light or millimeter-wave transmission signal from the radar in an appropriate detection direction (for example, forward in the travel direction), receives a reflected signal produced by the transmission signal being reflected by an object external to the subject vehicle, generates a beat signal by mixing the reflected signal and the transmission signal, and outputs the beat signal to the processing unit 13.

The vehicle state sensor 16 has a constitution provided with a velocity sensor that detects the velocity (vehicle velocity) of the subject vehicle; a position sensor that detects the present position and travel direction of the subject vehicle based on a positioning signal such as a global positioning system signal that measures the position of a vehicle using a satellite and a position signal transmitted from an information transmitter on the exterior of the subject vehicle, and moreover the detection result of an appropriate gyro sensor and acceleration sensor; a yaw rate sensor that detects the yaw angle (angle of rotation of the vehicle's center of gravity about the vertical axis) and the yaw rate (angular velocity of the vehicle's center of gravity about the vertical axis); a steering angle sensor that detects the steering angle (magnitude in the direction of steering angle input by the driver) and the actual steering angle corresponding to the steering angle, and sensors for detecting the ON/OFF state of the direction indicators and brakes, as vehicle information of the subject vehicle.

The object vehicle position detection portion 21 of the processing unit 13 detects a moving object, such as an object vehicle, that exists in the detection area of the camera or radar in the traveling direction of the subject vehicle based on the image data or beat signal input from the external sensor 15, and calculates the position of the object vehicle.

The object vehicle velocity detection portion 22 detects the velocity of the object vehicle based on the temporal change of the location of the object vehicle detected by the object vehicle position detection portion 21.

The object vehicle travel path estimating portion 23 estimates the travel path of the object vehicle based on the change in position of the object vehicle detected by the object vehicle position detection portion 21.

The subject vehicle travel path estimating portion 24 estimates the travel path of the subject vehicle based on the temporal change in the position of the subject vehicle detected by the vehicle state sensor 16, the running state of the subject vehicle, such as the velocity (vehicle velocity) of the subject vehicle detected by the vehicle velocity sensor, and the yaw rate of the subject vehicle as detected by the yaw rate sensor.

The collision judgment portion 25 judges whether or not there is a possibility of the subject vehicle and the object vehicle coming into contact or colliding based on the vehicle velocity of the object vehicle input from the object vehicle velocity detection portion 22, the object vehicle travel path input from the object vehicle travel path estimating portion 23, the travel path of the subject vehicle input from the subject vehicle travel path estimating portion 24, and the position of the subject vehicle detected by the vehicle state sensor 16.

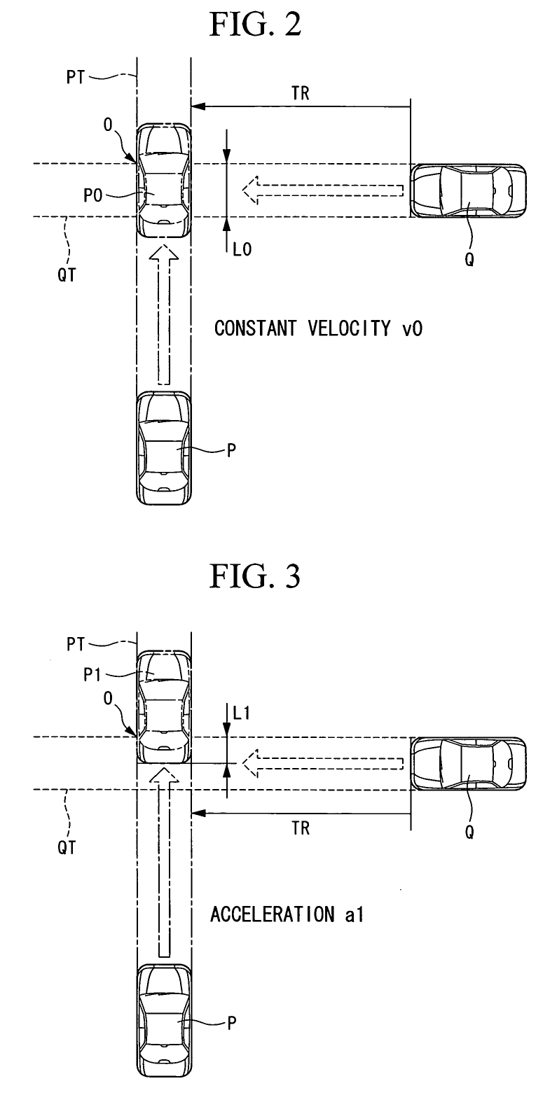

As shown in FIGS. 2 to 4, the collision judgment portion 25 estimates the arrival time TR required for an object vehicle Q to arrive at a predicted collision region O, which is the region where an estimated travel path PT of a subject vehicle P and an estimated travel path QT of the object vehicle Q intersect.

As shown for example in FIG. 2, the collision judgment portion 25 calculates an amount of overlap L0 between the estimated travel path QT and an estimated position P0 of the subject vehicle in the direction along the width direction of the estimated travel path QT. P0 is the estimated position at the point in time where in the subject vehicle P has traveled over the arrival time TR in the state of having maintained its present drive state (for example, its current velocity v0 and the like). When there is no overlap between the estimated travel path QT and the estimated position P0, the overlap amount L0 is zero or a negative value.

Based on the overlap amount L0, such as the overlap amount L0 being greater than zero, the collision judgment portion 25 judges there to be a possibility of the subject vehicle and an object vehicle coming into contact or colliding.

In the event of judging there to be a possibility of the subject vehicle and the object vehicle coming into contact or colliding, as shown in FIG. 3, the collision judgment portion 25 computes an amount of overlap L1 between the estimated travel path QT and an estimated position P1 of the subject vehicle in the direction along the width direction of the estimated travel path QT. P1 is the estimated position at the point of the subject vehicle having accelerated over arrival time TR in the state of maintaining a specified acceleration a1 from the current velocity v0 in order for the subject vehicle P to move away from the predicted collision region O and the object vehicle Q.

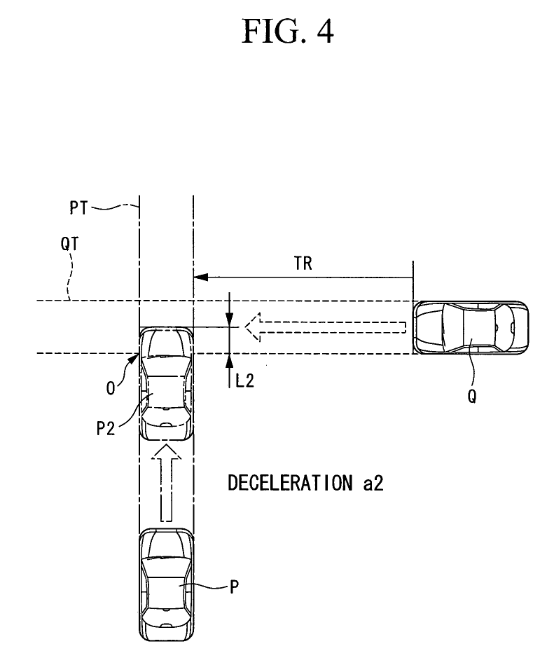

In addition, as shown in FIG. 4, the collision judgment portion 25 computes an amount of overlap L2 between the estimated travel path QT and an estimated position of the subject vehicle P2 in the direction along width direction of the estimated travel path QT. P2 is the estimated position at the point of the subject vehicle having decelerated over arrival time TR in the state of maintaining a specified deceleration a2 from the current velocity v0 in order for the subject vehicle P to move away from the predicted collision region O and the object vehicle Q.

Then the collision judgment portion 25 compares overlap amounts L0, L1, and L2 for each of the travel states of the subject vehicle P and thereby estimates the ease of the object vehicle Q to take evasive action in the event of avoiding a collision with the subject vehicle P. That is, as the amount of overlap L0, L1, L2 becomes smaller, the collision judgment portion 25 judges there to be an increase the ease of the object vehicle Q to take evasive action in the event of avoiding a collision with the subject vehicle P.

In accordance with the ease of evasive action by the object vehicle that is input from the collision judgment portion 25, the travel control portion 26 controls the travel of the subject vehicle so that the ease of evasive action increases.

As shown in FIGS. 2 to 4, in the event of the ease of the object vehicle Q to take evasive action changing depending on the velocity of the subject vehicle P, the travel control portion 26, so as to bring about an increase in the ease of evasive action by the object vehicle Q, outputs a control signal to control the drive power of the internal combustion engine 11, a control signal to control shifting of the transmission 12, and a control signal to control deceleration by the brake actuator 14 to execute acceleration control or deceleration control of the subject vehicle P.

The vehicle travel safety apparatus 10 according to the embodiment of the present invention has the aforementioned constitution. The operation of the vehicle travel safety apparatus 10 shall next be described.

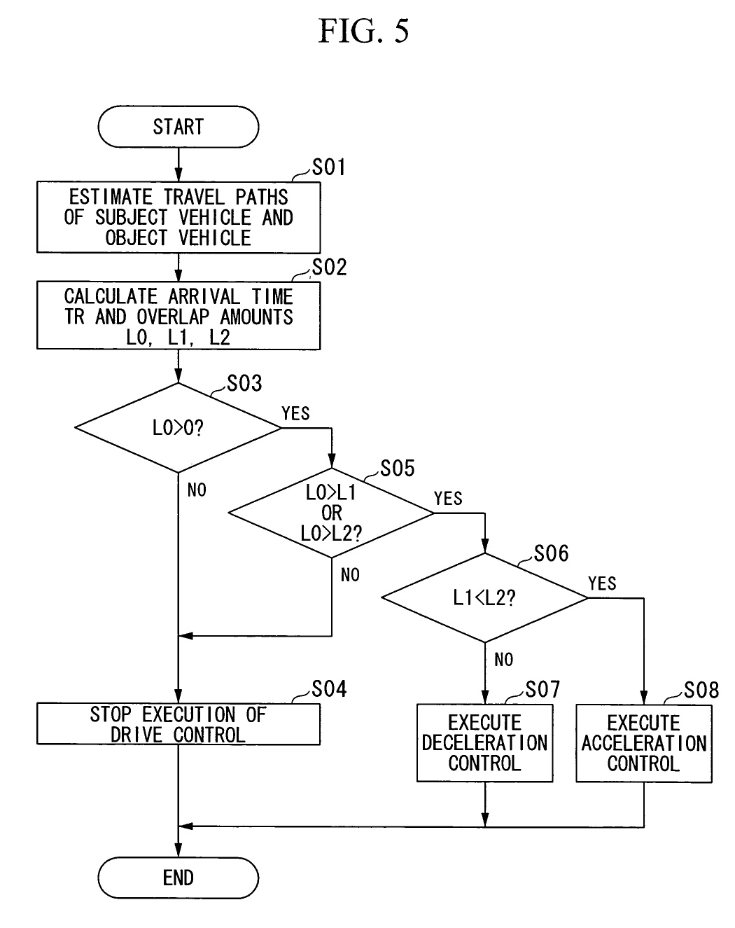

First, in step S01 shown in FIG. 5, the travel path of the object vehicle is estimated based on the position of the object vehicle detected from the output of the external sensor 15, and the travel path of the subject vehicle is estimated based on the travel state of the subject vehicle (such as the vehicle velocity and yaw rate) measured by the vehicle state sensor 16.

Then in step S02, the arrival time TR required for the object vehicle Q to reach the predicted collision region O, where the estimated travel path PT of the subject vehicle P and the estimated travel path QT of the object vehicle Q intersect is calculated. In addition, the aforementioned amounts of overlap L0, L1, and L2 are calculated.

Next in step S03, it is determined whether or not the amount of overlap L0 is greater than zero. If the determination result is “YES”, the processing proceeds to step S05 described below.

If the determination result is “NO”, i.e., it is determined that there is no possibility of the subject vehicle P and the object vehicle Q coming into contact or colliding, the processing proceeds to step S04.

In step S04, the execution of the drive control is stopped and the series of processes thereby ends.

In step S05, it is determined whether or not the overlap amount L0 is greater than the overlap amount L1, or whether or not the overlap amount L0 is greater than the overlap amount L2.

When the determination result is “NO”, i.e., it is determined that the ease of the object vehicle Q to take evasive action in the event of avoiding a collision with the subject vehicle P is higher by the subject vehicle P maintaining its current drive state and the processing proceeds to step S04.

On the other hand, when the determination result is “YES”, the processing proceeds to step S06.

In step S06, it is determined whether or not the overlap amount L1 is smaller than the overlap amount L2.

When the determination result is “NO”, i.e., it is determined that the ease of the object vehicle Q to take evasive action in the event of avoiding a collision with the subject vehicle P is highest when the subject vehicle P travels at a specified deceleration a2 from the current velocity v0, the processing proceeds to step S07, and the subject vehicle P is decelerated, whereby the series of processes ends.

On the other hand, when the determination result is “YES”, i.e., it is determined that the ease of the object vehicle Q to take evasive action in the event of avoiding a collision with the subject vehicle P is highest when the subject vehicle P travels at a specified acceleration a1 from the current velocity v0, the processing proceeds to step S08, and the subject vehicle P is accelerated, whereby the series of processes ends.

As described above, the vehicle travel safety apparatus 10 of the present embodiment controls the velocity (that is, acceleration or deceleration) of the subject vehicle so as to reduce the amount of overlap between the estimated travel path of the object vehicle and the estimated position of the subject vehicle in the direction along the width direction of the estimated travel path of the object vehicle. Thus, it is possible to improve the ease of the object vehicle to take evasive action by velocity control or steering control in the case of avoiding contact or a collision with the subject vehicle.

Due to the aforementioned action, evasive action by the object vehicle can reduce the possibility of contact or collision occurring even when it is judged that a collision is unavoidable solely based on travel control of the subject vehicle. In addition, in the case of a judgment that a collision is avoidable solely by travel control of the subject vehicle, in accordance with the predicted evasive action by the object vehicle, the minimum travel control required can be performed on the subject vehicle. It is thus possible to prevent excessive or unnecessary travel control from being executed on the subject vehicle.

In the above-described embodiment, the collision judgment portion 25, in accordance with the overlap amounts L0, L1, and L2 corresponding to the respective travel states of the subject vehicle P, judges whether there is the possibility of the subject vehicle P and the object vehicle Q coming into contact or colliding, and estimates the ease of evasive action in the event of the object vehicle Q avoiding a collision with the subject vehicle P, but the embodiment is not limited thereto. As a first modification example of the aforementioned embodiment, the collision judgment portion 25, in accordance with the amount of movement when the object vehicle avoids the subject vehicle in the lateral direction at the collision point between the subject vehicle and the object vehicle, may judge whether there is the possibility of the subject vehicle and the object vehicle coming into contact or colliding, and estimate the ease of evasive action in the event of the object vehicle avoiding a collision with the subject vehicle.

In the first modification example, the collision judgment portion 25 first estimates the estimated travel paths for the subject vehicle and the object vehicle in the case of both maintaining their present travel states. Then, it estimates a collision point CP where there is the possibility of the object vehicle coming into contact or colliding with the subject vehicle at an appropriate time, and estimates the amount of movement when the object vehicle avoids the subject vehicle in the lateral direction with respect to the collision point CP.

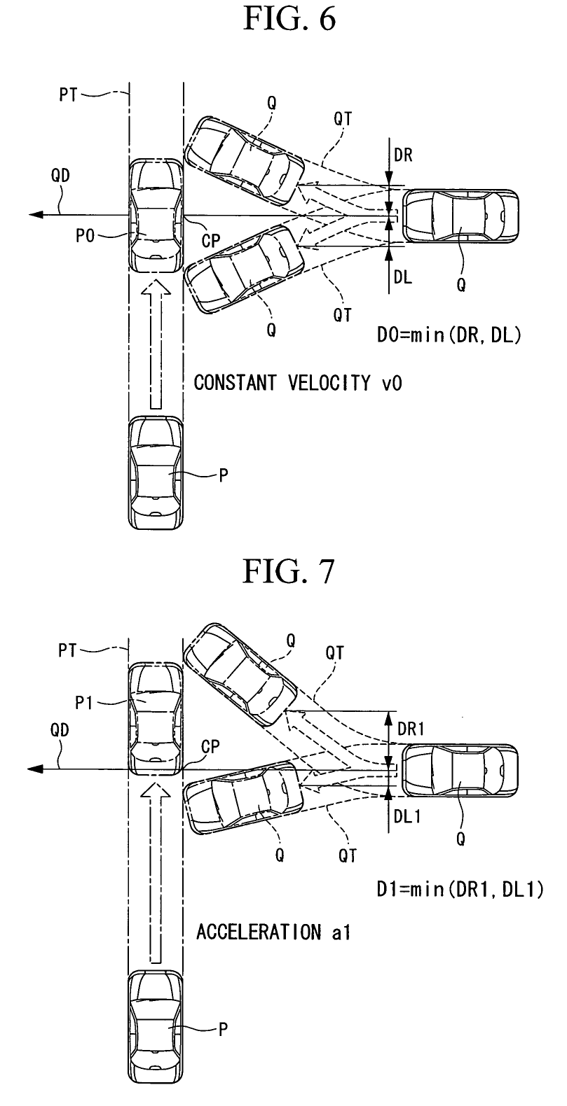

As shown in FIG. 6, the collision judgment portion 25 computes a rightward travel distance DR and a leftward travel distance DL in the event of the subject vehicle P traveling in the state of having maintained its present drive state (for example, its current velocity v0). The travel distances DR and DL are lateral distances that the object vehicle Q, by turning to the right or left of its travel direction QD by means of its turning mechanism, is required to travel for avoiding contact or a collision with the estimated position P0 of the subject vehicle at an appropriate time. A lateral direction here means a direction perpendicular to the travel direction of the object vehicle Q, such as the width direction of the object vehicle Q. Then, the smaller of the distances DR and DL (that is, min (DR, DL)) is set as the required steering evasion amount D0.

Based on the required steering evasion amount D0, such as the case when the required steering evasion amount D0 is greater than zero, the collision judgment portion 25 judges there to be a possibility for the subject vehicle and the object vehicle to make contact or collide.

In the first modification example, as shown in FIG. 6, the change, in the lateral direction, of the position of the center of the back end portion of the object vehicle Q in the width direction at the point of having avoided contact with the subject vehicle P is set as the distance DR and DL, without being limited thereto. The distances DR and DL may be set with respect to a suitable position of the object vehicle Q.

When the collision judgment portion 25 has judged there to be a possibility for the subject vehicle and the object vehicle to make contact or collide, as shown in FIG. 7, it computes a rightward travel distance DR1 and a leftward travel distance DL1 in the case of accelerated travel of the subject vehicle P in the state of maintaining a specified acceleration a1 from the current velocity v0 in order to move away from the object vehicle Q. The travel distances DR1 and DL1 are lateral distances that the object vehicle Q, by turning to the right or left, respectively, of its travel direction QD by means of its turning mechanism, is required to travel for avoiding contact or collision with the estimated position P1 of the subject vehicle at an appropriate time. Then, the smaller of the distances DR1 and DL1 (that is, min (DR1, DL1)) is set as the required steering evasion amount D1.

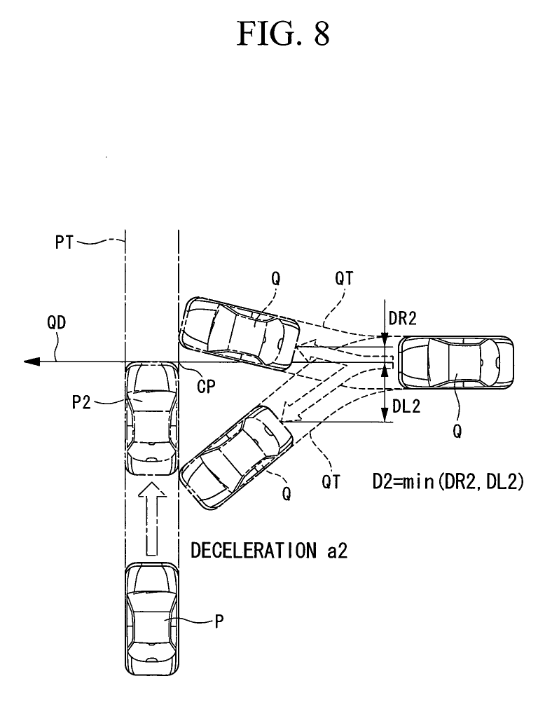

In addition, as shown in FIG. 8, the collision judgment portion 25 computes a rightward travel distance DR2 and a leftward travel distance DL2 in the case of decelerated travel of the subject vehicle P in the state of maintaining a specified deceleration a2 from the current velocity v0 in order to move away from the object vehicle Q. The travel distances DR2 and DL2 are lateral distances that the object vehicle Q, by turning to the right or left, respectively, of its travel direction QD by means of its turning mechanism, is required to travel for avoiding contact or collision with the estimated position P2 of the subject vehicle at an appropriate time. Then, the smaller of the distances DR2 and DL2 (that is, min (DR2, DL2)) is set as the required steering evasion amount D2.

Then, the collision judgment portion 25 compares the required steering evasion amounts D0, D1, and D2 corresponding to each of the travel states of the subject vehicle P and thereby estimates the ease of evasive action in the event of the object vehicle Q avoiding a collision with the subject vehicle P. That is, as the required steering evasion amounts D0, D1, and D2 becomes smaller, the collision judgment portion 25 judges there to be an increase in the ease of evasive action in the event of the object vehicle Q avoiding a collision with the subject vehicle P.

The operation of the vehicle travel safety apparatus 10 according to the first modification example shall next be described.

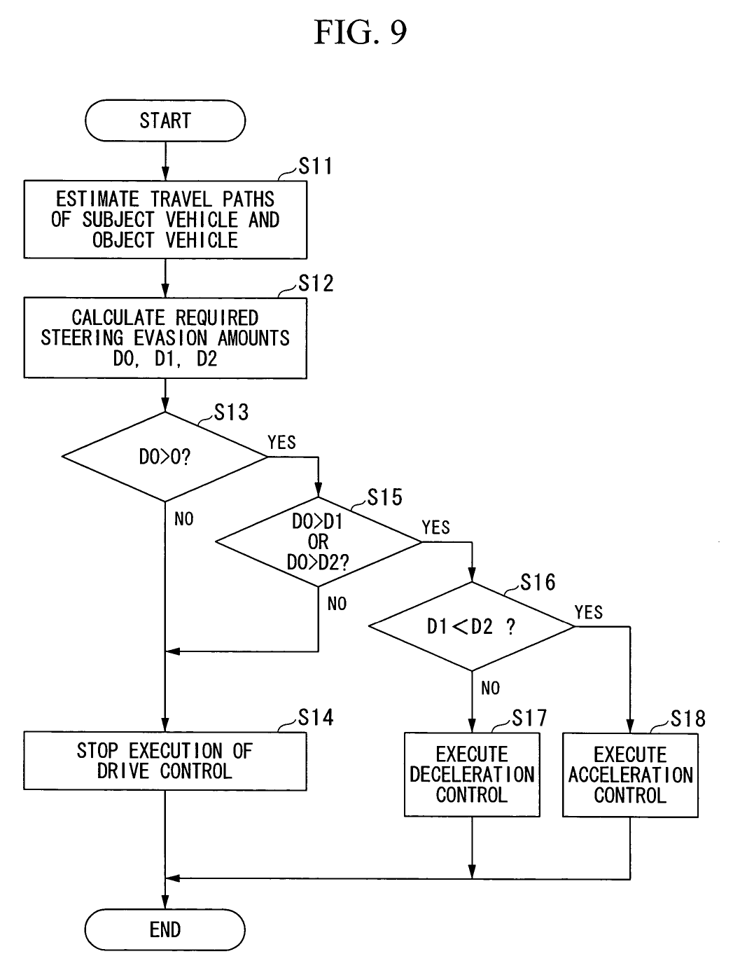

First, in step S11 shown in FIG. 9, the travel path of the object vehicle is estimated based on the position of the object vehicle detected from the output of the external sensor 15, and the travel path of the subject vehicle is estimated based on the running state of the subject vehicle (such as the vehicle velocity and yaw rate).

Then in step S12, the required steering evasion amounts D0, D1, and D2 are determined in the aforementioned manner.

Next in step S13, it is determined whether or not the required steering evasion amount D0 is greater than zero. If the determination result is “YES”, the processing proceeds to step S15 described below.

If the determination result is “NO”, i.e., it is determined that there is no possibility of the subject vehicle P and the object vehicle Q coming into contact or colliding, and the processing proceeds to step S14.

In step S14, the execution of the drive control is stopped and the series of processes thereby ends.

In step S15, it is determined whether the evasion amount D0 is greater than the evasion amount D1, or whether the evasion amount D0 is greater than the evasion amount D2.

When the determination result is “NO”, i.e., it is determined that the ease of the object vehicle Q to take evasive action in the event of avoiding a collision with the subject vehicle P is higher by the subject vehicle P maintaining its current drive state, and the processing proceeds to step S14.

On the other hand, when the determination result is “YES”, the processing proceeds to step S16.

In step S16, it is determined whether or not the evasion amount D1 is smaller than the evasion amount D2.

When the determination result is “NO”, i.e., it is determined that the ease of the object vehicle Q to take evasive action in the event of avoiding a collision with the subject vehicle P is highest when the subject vehicle P travels at a specified deceleration a2 from the current velocity v0, the processing proceeds to step S117, and the subject vehicle P is decelerated, whereby the series of processes ends.

On the other hand, when the determination result is “YES”, i.e., it is determined that the ease of the object vehicle Q to take evasive action in the event of avoiding a collision with the subject vehicle P is highest when the subject vehicle P travels at a specified acceleration a1 from the current velocity v0, the processing proceeds to step S18, and the subject vehicle P is accelerated, whereby the series of processes ends.

In the first modification example, the amount of movement when the object vehicle avoids the subject vehicle in the lateral direction was computed as a distance in the lateral direction (that is, the rightward travel distance DR and the leftward travel distance DL), but is not limited thereto. For example, it may be any one of the yaw rate, lateral acceleration, and steering angle (or actual steering angle) of the object vehicle that is required to avoid the occurrence of contact or collision with the subject vehicle.

The aforementioned embodiment estimated the ease of the object vehicle to take evasive action, which changes in accordance with the velocity state of the subject vehicle (that is, whether the subject vehicle is in an accelerating or a decelerating), but it is not limited thereto. A second modification example of the aforementioned embodiment may estimate the ease of the object vehicle to take evasive action as changing in accordance with the steering state of the subject vehicle.

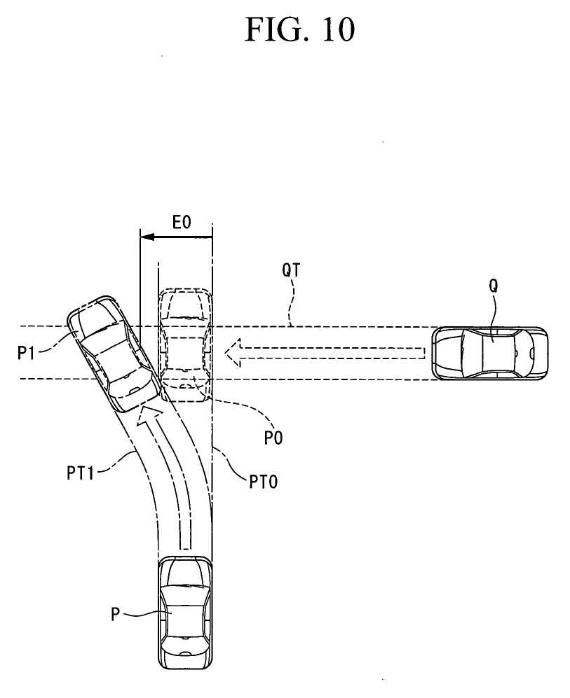

In the second modification example, as shown in FIG. 10, the collision judgment portion 25 estimates an estimated travel path PT0 of the subject vehicle P and estimated travel path QT of the object vehicle Q in the case of both vehicles maintaining their current travel states, based on the vehicle velocity of the object vehicle input from the object vehicle velocity detection portion 22, the travel path of the object vehicle input from the object vehicle travel path estimating portion 23, the travel path of the subject vehicle input from the subject vehicle travel path estimating portion 24, and the position of the subject vehicle detected by the vehicle state sensor 16. The collision judgment portion 25 then judges whether or not there is the possibility of the object vehicle Q coming into contact or colliding with the side portion of the estimated position P0 of the subject vehicle at an appropriate time.

When this determination result is such that it is determined that there is a possibility of the object vehicle Q coming into contact or colliding with the side portion of the estimated position P0 of the subject vehicle, it is determined that in the case of the subject vehicle P turning in a direction to the side opposite the side with which the object vehicle Q will come into contact or collide (that is, in a direction away from the object vehicle Q), the ease of the object vehicle Q to take evasive action increases. On the other hand, it is determined that in the case of the subject vehicle P turning in a direction of the side with which the object vehicle Q will come into contact or collide (that is, the direction approaching the object vehicle Q), the ease of the object vehicle Q to take evasive action decreases. In both cases, the directions in which the subject vehicle P turns are lateral directions, that is, directions perpendicular to the travel direction of the subject vehicle P.

Depending on the ease of the object vehicle to take evasive action as input from the collision judgment portion 25, the travel control portion 26 outputs a control signal that controls the steering of the subject vehicle by the steering mechanism (not illustrated) by an EPS actuator 18.

FIG. 10 shows the example of the travel control portion 26 outputting a control signal to instruct the subject vehicle P to turn in a direction away from the object vehicle Q so that the ease of the object vehicle Q to take evasive action increases. Thereby, the subject vehicle P travels along estimated travel path PT1, turning in a direction leftward of the travel direction. An estimated position P1 of the subject vehicle in the case of traveling along this estimated path PT1 is a distance E0 further from the object vehicle Q along the estimated travel path QT than the estimated position P0 at the appropriate time. It is thus possible to improve the ease of the object vehicle Q to take evasive action in the event of avoiding contact or a collision with the subject vehicle P by velocity control (i.e., deceleration control) or steering control, and to reduce the possibility of the occurrence of the two vehicles coming into contact or colliding.

The aforementioned embodiment described the case of the object vehicle approaching from the side of the subject vehicle, but it is not limited thereto. For example, in the case of the object vehicle approaching from the front or rear of the subject vehicle, controlling the steering of the subject vehicle so that the amount of overlap between the estimated path of the object vehicle and the estimated position of the subject vehicle in the direction along the width direction of the estimated path of the object vehicle, or acceleration or deceleration of the subject vehicle so as to move away from the object vehicle may be performed at the point in time in which the distance between the subject vehicle and the object vehicle at the front or rear of the subject vehicle is equal to zero.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A travel safety apparatus for a vehicle, the apparatus comprising:
an object detecting device that detects objects around the vehicle;
a first travel path estimating device that estimates a travel path of a moving object among the objects;
a velocity calculating device that calculates a velocity of the moving object based on a detection result of the object detecting device;
a travel state detecting device that detects a travel state of the vehicle;
a second travel path estimating device that estimates the travel path of the vehicle based on a detection result of the travel state detecting device;
a collision judgment device that determines whether or not there is a possibility of a collision occurring between the moving object and the vehicle based on an estimated moving object travel path that is estimated by the first travel path estimating device, an estimated vehicle travel path that is estimated by the second travel path estimating device, the velocity of the moving object that is calculated by the velocity calculating device, and the travel state; and
a travel control device that controls the travel of the vehicle when a determination result of the collision judgment device indicates a possibility of a collision occurring,
wherein the collision judgment device estimates an ease of evasive action in the event of the moving object avoiding a collision with the vehicle, and the travel control device controls the travel of the vehicle so that the ease of evasive action increases.

2. A travel safety apparatus according to claim 1, wherein the collision judgment device estimates a point of collision between the moving object and the vehicle based on the estimated moving object travel path, the estimated vehicle travel path, the velocity of the moving object, and the travel state, and wherein
the travel control device controls the travel of the vehicle so that the vehicle moves away from the point of collision and the moving object.

3. A travel safety apparatus according to claim 1, further comprising
a velocity control device that controls a velocity of the vehicle, wherein
the collision judgment device estimates an amount of overlap between the vehicle and the estimated moving object travel path in the width direction of the estimated moving object travel path at the point in time when the moving object is estimated to arrive at the collision point, based on the estimated moving object travel path, the estimated vehicle travel path, the velocity of the moving object, and the travel state, and wherein
the velocity control device controls the velocity of the vehicle so that the amount of overlap decreases.

4. A travel safety apparatus according to claim 1, wherein the ease of evasive action is one in the event of the moving object avoiding a collision with the vehicle by a steering operation.

5. A travel safety apparatus according to claim 1, further comprising
a velocity control device that controls a velocity of the vehicle, wherein
the collision judgment device estimates a collision point between the moving object and the vehicle based on the estimated moving object travel path, the estimated vehicle travel path, the velocity of the moving object, and the travel state, and calculates an amount of movement when the moving object avoids the vehicle in a lateral direction before arriving at the collision point, and wherein
the velocity control device controls the velocity of the vehicle so that the amount of movement decreases.

6. A travel safety apparatus according to claim 1, wherein the ease of evasive action is one in the event of the moving object avoiding a collision with the vehicle by a braking operation.

7. A travel safety apparatus according to claim 1, further comprising
a steering control device that controls steering of the vehicle, wherein
the collision judgment device determines whether or not the moving object is to collide with a side portion of the vehicle based on the estimated moving object travel path, the estimated vehicle travel path, the velocity of the moving object, and the travel state, and wherein
the steering control device controls the steering of the vehicle so that the vehicle moves away from the moving object when it is determined that the moving object is to collide with the side portion of the vehicle.

8. A travel safety apparatus according to claim 2, further comprising
a velocity control device that controls a velocity of the vehicle, wherein
the collision judgment device estimates an amount of overlap between the vehicle and the estimated moving object travel path in the width direction of the estimated moving object travel path at the point in time when the moving object is estimated to arrive at the collision point, based on the estimated moving object travel path, the estimated vehicle travel path, the velocity of the moving object, and the travel state, and wherein
the velocity control device controls the velocity of the vehicle so that the amount of overlap decreases.

9. A travel safety apparatus according to claim 2, wherein the ease of evasive action is one in the event of the moving object avoiding a collision with the vehicle by a steering operation.

10. A travel safety apparatus according to claim 2, further comprising
a velocity control device that controls a velocity of the vehicle, wherein
the collision judgment device estimates a collision point between the moving object and the vehicle based on the estimated moving object travel path, the estimated vehicle travel path, the velocity of the moving object, and the travel state, and calculates an amount of movement when the moving object avoids the vehicle in a lateral direction before arriving at the collision point, and wherein
the velocity control device controls the velocity of the vehicle so that the amount of movement decreases.

11. A travel safety apparatus according to claim 2, wherein the ease of evasive action is one in the event of the moving object avoiding a collision with the vehicle by a braking operation.

12. A travel safety apparatus according to claim 2, further comprising
a steering control device that controls steering of the vehicle, wherein
the collision judgment device determines whether or not the moving object is to collide with a side portion of the vehicle based on the estimated moving object travel path, the estimated vehicle travel path, the velocity of the moving object, and the travel state, and wherein
the steering control device controls the steering of the vehicle so that the vehicle moves away from the moving object when it is determined that the moving object is to collide with the side portion of the vehicle.

13. A travel safety apparatus according to claim 4, further comprising
a velocity control device that controls a velocity of the vehicle, wherein
the collision judgment device estimates a collision point between the moving object and the vehicle based on the estimated moving object travel path, the estimated vehicle travel path, the velocity of the moving object, and the travel state, and calculates an amount of movement when the moving object avoids the vehicle in a lateral direction before arriving at the collision point, and wherein
the velocity control device controls the velocity of the vehicle so that the amount of movement decreases.

14. A travel safety apparatus according to claim 5, wherein at least one of a moving distance in the lateral direction, a yaw rate, a lateral acceleration, and a steering angle of the moving object is used as the amount of movement.

15. A travel safety apparatus according to claim 6, further comprising
a steering control device that controls steering of the vehicle, wherein
the collision judgment device determines whether or not the moving object is to collide with a side portion of the vehicle based on the estimated moving object travel path, the estimated vehicle travel path, the velocity of the moving object, and the travel state, and wherein
the steering control device controls the steering of the vehicle so that the vehicle moves away from the moving object when it is determined that the moving object is to collide with the side portion of the vehicle.

16. A travel safety apparatus according to claim 9, further comprising
a velocity control device that controls a velocity of the vehicle, wherein
the collision judgment device estimates a collision point between the moving object and the vehicle based on the estimated moving object travel path, the estimated vehicle travel path, the velocity of the moving object, and the travel state, and calculates an amount of movement when the moving object avoids the vehicle in a lateral direction before arriving at the collision point, and wherein
the velocity control device controls the velocity of the vehicle so that the amount of movement decreases.

17. A travel safety apparatus according to claim 10, wherein at least one of a moving distance in the lateral direction, a yaw rate, a lateral acceleration, and a steering angle of the moving object is used as the amount of movement.

18. A travel safety apparatus according to claim 11, further comprising
a steering control device that controls steering of the vehicle, wherein
the collision judgment device determines whether or not the moving object is to collide with a side portion of the vehicle based on the estimated moving object travel path, the estimated vehicle travel path, the velocity of the moving object, and the travel state, and wherein
the steering control device controls the steering of the vehicle so that the vehicle moves away from the moving object when it is determined that the moving object is to collide with the side portion of the vehicle.

19. A travel safety apparatus according to claim 13, wherein at least one of a moving distance in the lateral direction, a yaw rate, a lateral acceleration, and a steering angle of the moving object is used as the amount of movement.

20. A travel safety apparatus according to claim 16, wherein at least one of a moving distance in the lateral direction, a yaw rate, a lateral acceleration, and a steering angle of the moving object is used as the amount of movement.
